(19) United States
(12) Patent Application Publication
(10) Pub. No.: US 2003/0192481 A1
(43) Pub. Date: Oct. 16, 2003

(54) Litter box liner impregnated with baking soda

(76) Inventors: Benjamin M. Schulein JR., St. Louis, MO (US); Marty Johnes, Alton, IL (US)

Correspondence Address: BLACKWELL SANDERS PEPER MARTIN LLP, 720 OLIVE STREET, SUITE 2400, ST. LOUIS, MO, 63101, US

(21) Appl. No.: 10/406,534

(22) Filed: Apr. 3, 2003

Related U.S. Application Data
(60) Provisional application No. 60/371,809, filed on Apr. 11, 2002.

(51) Int. Cl. A01K 29/00

(52) U.S. Cl. 119/170

(57) ABSTRACT

An animal litter box liner has a sufficient amount of sodium bicarbonate incorporated into the sheet-like material of the liner to facilitate the control of odors from the litter box when the litter box is used by an animal. The amount of sodium bicarbonate used is small enough that it does not compromise the structural integrity of the liner. The amount of sodium bicarbonate incorporated into the liner is preferably within the range of from about 2% to about 12% by volume.

### CROSS-REFERENCE TO RELATED APPLICATION

This application claims benefit of the filing date of U.S. Provisional Application No. 60/371,809, filed Apr. 11, 2002.

### BACKGROUND OF THE INVENTION

The present invention relates generally to animal litter box liners, and, more particularly, to a cat litter box liner having sodium bicarbonate incorporated into the material thereof.

The use of sodium bicarbonate (“baking soda”) to reduce or eliminate odors of various kinds, such as food odors, is well known. Previously, there have been trash can liners that have been coated with baking soda for reduction of garbage odors. Also, patents have issued for devices that use sodium bicarbonate for odor control generally. These include U.S. Pat. No. 5,254,401, issued to Kelch et al., which discloses a packaging material for controlled atmosphere packaging. The package is primarily directed at storage of produce and includes a blowing agent containing sodium bicarbonate in an adhesive layer of a liner.

Other patents have issued related specifically to odors created by pets in their use of litter for purposes of defecation and urination. For example, U.S. Pat. No. 4,203,388, which issued to Cortigene et al, discloses an animal litter specifically incorporating sodium bicarbonate in the litter material as a deodorant.

More broadly, U.S. Pat. No. 5,630,377 discloses a pet toilet assembly having bundles of strips formed of recycled newspaper that is capable of being chemically treated with deodorants, germicidal agents, etc. Kamrath et al. were issued U.S. Pat. No. 5,715,772, which discloses a pad for use in a pet carrier and has an optional deodorizer and disinfectant applied to the absorbent layer to neutralize odors from the animal waste. Thus a need has long existed for means by which to deodorize animal litter boxes, but until this time it has never been suggested to actually incorporate sodium bicarbonate as a deodorizer directly into the material from which the box liner is formed; that is, not as a coating or a layer, but as actually part of the liner material per se.

### SUMMARY OF THE INVENTION

The present invention addresses such a need by introducing a sufficient amount of baking soda into the plastic sheet material of the litter box liners during manufacture thereof to thereby reduce or eliminate odors that ordinarily emanate from a utilized animal litter box. The amount of sodium bicarbonate in the new litter box liners is controlled so as to avoid risk to the structural integrity of the liner. It is intended that the new liner reduce cat box odors but not break under the weight of litter therein, especially when the litter is wet with urine. It is further intended that the new litter box liners are inexpensive and easy to manufacture.

Thus, in keeping with the above goals of the invention, the present invention is, briefly, an animal litter box liner having a sufficient amount of sodium bicarbonate incorporated into the material of the liner to facilitate control of natural odors from a litter box when the litter box is used by an animal, yet which does not interfere with the structural integrity of the liner to such an extent that the usefulness of the liner is jeopardized.

### BRIEF DESCRIPTION OF THE DRAWINGS

FIG. 1 is a schematic view of the process of forming the new liners.

### DETAILED DESCRIPTION

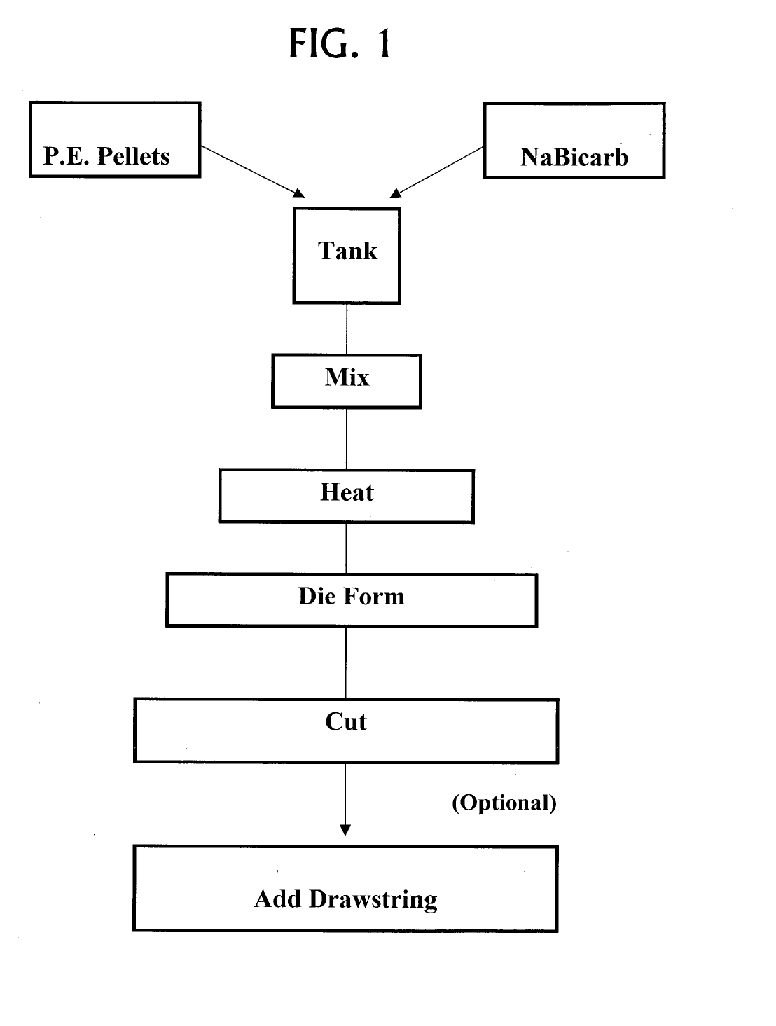

The litter box liners of the present invention are manufactured, in part, in keeping with conventional methods including melting plastic pellets and forming the liquid plastic into sheets of predetermined thickness, then cutting the sheets to a predetermined size. The method is illustrated schematically in FIG. 1. If desired a drawstring can be incorporated into a hem around the perimeter of the liner for use in facile closure of the liner after use is completed.

The novel aspect of the new liners is the incorporation of baking soda directly into the plastic material (preferably polyethylene) before forming the sheets of material from which the liners are cut. This is accomplished by combining a predetermined amount of baking soda with an appropriate amount of plastic pellets. The mixture of sodium bicarbonate and plastic pellets is thoroughly melted and mixed, so as to be substantially homogenous prior to forming the plastic sheeting from which the liners are cut. Thus the liner material is thoroughly impregnated throughout its substance with sodium bicarbonate. The preferred amount of sodium bicarbonate is about 2% to about 12% by volume, with an especially preferred amount of about 7% to about 8% by volume. Though various methods may exist for combining the baking soda with plastic pellets and subsequently producing sheets therefrom, a preferred method is provided in the example below. Any other suitable method may be used.

### EXAMPLE

To produce sodium bicarbonate-impregnated plastic sheets for making litter box liners in accordance with the teachings of the present invention, 1400 kgs high-density polyethylene (HDPE) pellets were combined in a tank with 100 kgs sodium bicarbonate. The HDPE and sodium bicarbonate were thoroughly mixed and the resulting mixture fed into a heating drum and die for sheet making. The resulting sheet liners can be cut to any desired size.

Although HDPE is used in the example above, low-density polyethylene (LDPE) may also be used. The resulting sheets are formed preferably in the range of from about 1.0 to about 3.0 mil of either HDPE or LDPE. Any other suitable strength of HDPE or LDPE may be used. Further, any other plastic, such as polypropylene or polyvinyl chloride, or suitable non-plastic material may be used.

As noted above, the sodium-bicarbonate impregnated sheets may be cut to any desirable size. Preferably, the sheets are cut to a size of at least 14 inches by 30 inches.

The new liner has a relatively conventional appearance like any other cat box liner. It may be a flat sheet or provided with a drawstring in a hem or gusset in known manner. Moreover, the liner may be formed of either high or low density polyethylene, and the size (usually at least 14 inches by at least 30 inches) and general shape of the liner may vary in any manner desired, as the invention resides in the chemical make up of the liner sheeting material per se, rather in the structure or shape of the liner.

The function of the invention is dual in that it reduces odor and simultaneously provides a way to keep a litter box clean and sanitary with a single device. The new liner accomplishes both functions without the necessary addition of expensive substance-enhanced litters. Because of the incorporation of baking soda directly into the liner material per se, generic, unsupplemented animal litters can be used without build up of extremely objectionable odors from, for example, cat urine.

In view of the foregoing, it will be seen that the several objects of the invention are achieved and other advantages are attained. Although the foregoing includes a description of the best mode contemplated for carrying out the invention, various modifications are conceivable.

As various modifications could be made in the constructions and methods herein without departing from the scope of the invention it is intended that all matter contained in the foregoing description or shown in the accompanying drawing shall be interpreted as illustrative rather than limiting.

We claim:

1. An animal litter box liner having a sufficient amount of sodium bicarbonate incorporated into the material of the liner to facilitate control of natural odors from a litter box within which the liner is placed, in normal working position, when the litter box is used by an animal and yet which does not interfere with the structural integrity of the liner to an extent to which the usefulness of the liner is jeopardized.

2. The litter box liner of claim 1, wherein the amount of sodium bicarbonate in the liner is within the range of about 2% to about 12%.

3. The litter box liner of claim 2, wherein the amount of sodium bicarbonate in the liner is within the range of about 6% to about 8%.

4. The litter box liner of claim 1, wherein the litter box liner is formed of a material including polyethylene.

5. The litter box liner of claim 4, wherein the polyethylene is formed in a range of about 1.0 mil to about 3.0 mil low density polyethylene.

6. The litter box liner of claim 5, wherein the polyethylene is formed in a range of about 1.0 mil to about 2.0 mil low density polyethylene.

7. The litter box liner of claim 4, wherein the polyethylene is formed in a range of about 1.0 mil to about 3.0 mil high density polyethylene.

8. The litter box liner of claim 7, wherein the polyethylene is formed in a range of about 1.0 mil to about 2.0 mil high density polyethylene.

9. The litter box liner of claim 1, wherein the liner is formed to a size of at least 14 inches by at least 30 inches.

10. The litter box liner of claim 1, wherein the liner is provided with a drawstring.

11. The litter box liner in claim 1, wherein the liner is formed to a size of about 18 inches wide by up to about 36 inches long.

12. The litter box liner of claim 1, wherein the liner is formed to a size of about 44 inches by about 38 inches.

13. The litter box liner of claim 1, wherein the liner is formed to a size of about 36 inches by about 31 inches.

14. The litter box liner of claim 1, wherein the liner is formed to a size of about 40 inches by about 38 inches.

15. A method of making sheets of polyethylene impregnated with sodium bicarbonate, the method comprising the steps of:
introducing 1400 kgs polyethylene pellets into a tank;
adding 100 kgs sodium bicarbonate to the tank with the polyethylene pellets;
mixing the polyethylene pellets and the sodium bicarbonate;
heating the mixture of polyethylene pellets and sodium bicarbonate; and
die forming the heated mixture into sheets for making liners.

16. The method of claim 15, and further comprising the step of cutting the sheets into pre-selected sizes to form litter box liners.

17. The method of claim 15, wherein the step of adding polyethylene pellets consists of adding high-density polyethylene pellets.

18. The method of claim 15, wherein the step of adding polyethylene pellets consists of adding low-density polyethylene pellets.

19. The method of claim 15, wherein the step of adding polyethylene pellets is replaced with the step of adding pellets selected from the group consisting of polypropylene, and polyvinyl chloride.

20. The method of claim 15, and further comprising, after the step of die-forming, the step of cutting the sheets into liners of a pre-selected size.
